(19) United States
(12) Patent Application Publication
(10) Pub. No.: US 2019/0122566 A1
(43) Pub. Date: Apr. 25, 2019

(54) METHOD FOR SECURING A PROVISIONAL ITINERARY FOR AN AIRCRAFT, CORRESPONDING SYSTEM AND COMPUTER PROGRAM

(71) Applicant: THALES, Courbevoie (FR)

(72) Inventors: Laurent FLOTTE, Toulouse (FR); Ronan DEMOMENT, Toulouse (FR); Stéphane FLEURY, Toulouse (FR)

(21) Appl. No.: 16/165,834

(22) Filed: Oct. 19, 2018

(30) Foreign Application Priority Data
Oct. 20, 2017 (FR) 17 01093

(51) Int. Cl. G08G 5/00; G08G 5/04

(52) U.S. Cl. CPC G08G 5/0034; G08G 5/006; G08G 5/04

(57) ABSTRACT

A method for securing a provisional aircraft itinerary with respect to potential threats associated with geographical coordinates, according to which the provisional itinerary includes geographical coordinates of waypoints, two successive waypoints defining an anticipated route segment with the two waypoints as ends, the method comprising carrying out a first risk detection, as a function of at least the geographical coordinates of the ends of each segment between two waypoints and threats to identify potentially at-risk (segment, threat) pairs, wherein each segment is split into segment sections, and carrying out a second risk detection for each pair, in order, based on at least the geographical coordinates of the sections of the segment of the pair and at least the geographical coordinates of the threat of the pair, to determine whether the threat is confirmed as presenting a collision risk with the segment.

### CROSS-REFERENCE TO RELATED APPLICATIONS

This application claims priority of French Patent Application No. 17 01093, filed on Oct. 20, 2017.

### FIELD OF THE INVENTION

The present invention relates to the field of the secure use of a provisional itinerary. A provisional itinerary for an aircraft is often calculated using tools on the ground. The provisional itinerary can next be modified by the teams on the ground or in flight.

### BACKGROUND OF THE INVENTION

A provisional itinerary refers to the flight plan or the path of an aircraft. It generally comprises identifying a series of waypoints associated with a speed of the aircraft and an anticipated passage time by these waypoints, all of which is calculated so as to reduce fuel consumption.

The securing of a provisional itinerary seeks to guarantee inter alia that on the one hand, the itinerary does not clash with elements presenting a potential threat for the aircraft, such as:
the terrain or an obstacle;
a dangerous deteriorated weather situation;
other anticipated traffic (air or other);
   and that on the other hand, the anticipated itinerary does not encounter other potentially threatening elements, for example that it does not use prohibited or risky flyovers zones (towns that it is prohibited to fly over, war or military zones, periodic events such as fireworks, etc.), some of these zones thus being able to be stamped “prohibited” or “risky” only on certain days and/or at certain times.

### SUMMARY OF THE DESCRIPTION

The present invention more specifically relates to a method, implemented by computer, for securing a provisional itinerary calculated for an aircraft with respect to a set of elements representing potential threats, each element being associated with characteristics comprising at least geographical coordinates, according to which the calculated provisional itinerary for the aircraft comprises a list of waypoints of the aircraft each associated with geographical coordinates, two successive waypoints defining an anticipated route segment with said two waypoints as ends; said method comprising the following steps:

a first step for detecting risks is carried out based on at least the geographical coordinates of the ends of each segment and at least the geographical coordinates of the elements for identifying one or more (segment, element) at-risk pairs where the element of such a pair presents a safety risk for the aircraft in the segment of said pair.

The devices for securing a provisional itinerary calculated for an aircraft generally only take a limited set of threats into account. They are suitable for validating an itinerary calculated only by them on the one hand, and on the other hand, they require very substantial computing power, since they are based on complete sampling of the itinerary.

Furthermore, other elements make it possible to secure a calculated route: messages from air traffic services (ATS) sent to aircraft and coordinating the traffic of various aircraft, messages relative to the weather from the flight information service. Alerts from the terrain awareness and warning system (TAWS) also contribute to securing the few minutes of flight that come from a calculated itinerary (typically 2 min.), by detecting, on this timescale, an abnormal configuration of the vehicle (i.e., landing situation and non-deployed landing gear), proximity to the terrain or obstacles compared to flight parameters (speed, altitude) with abacuses. The significant volume of data to be analyzed to secure a provisional itinerary comes, in multiple formats, from various sources, depending on the nature of the data, the timescale of interest (short or long term), the geographical environment in question (close to the runway, over the ocean when the vehicle is cruising), making the synthesis that much more complex to carry out.

To that end, according to a first aspect, the invention proposes a method, carried out by computer, for securing a provisional itinerary calculated for an aircraft of the aforementioned type, characterized in that each segment being split into segment sections each associated with geographical coordinates, a second risk detection step is next carried out for each (segment, element) at-risk pair identified in the first step, in order, based on at least the geographical coordinates of the sections of the segment of the pair and at least the geographical coordinates of the element of the pair, to determine whether said element is confirmed as presenting a collision risk with the segment of said pair.

The present invention, by first proposing a macro-analysis, then a detailed analysis done only on the elements detected as critical during the macro-analysis, thus makes it possible to reduce the computing resources necessary to validate and secure the anticipated itinerary.

In embodiments, the securing method according to the invention further includes one or more of the following features:
in the first risk detection step, it is determined whether an element is within a 3D volume associated with a segment and defined based on at least the coordinates of each segment, said 3D volume encompassing said segment and the (segment, element) pair being identified as at-risk pair as a function of said determination;
the coordinate system of the coordinates has 3 dimensions X, Y and Z and in the first risk detection step, in order to determine whether an element is located within a 3D volume, a comparison is first done of the coordinates of the element and the volume according to one of said dimensions, respectively two of said dimensions, the (segment, element) pair being selected based on said comparison, then a comparison is done, only if the pair has been selected, of the coordinates of the element and the volume according to the last two dimensions, respectively the last dimension, the (segment, element) pair being identified as at-risk pair as a function of said comparison;
the coordinate system comprises 3 dimensions X, Y and Z and the threats comprise obstacles and/or deteriorated weather situations and/or other anticipated traffic; the threat elements are shown by polygons in two-dimensional space (X,Y), and in the second detection step, sections of the segment are determined that are closest to the apices of a polygon and the elements are confirmed as presenting a collision risk in the second detection step as a function of said determined sections, and segment portions considered as being at-risk for said elements are calculated as a function of said determined sections and geographical coordinates of said elements.

According to a second aspect, the present invention proposes a system for securing a provisional itinerary calculated for an aircraft with respect to a set of elements representing potential threats, each element being associated with characteristics comprising at least geographical coordinates, the calculated provisional itinerary for the aircraft comprising a list of waypoints of the aircraft each associated with geographical coordinates, two successive waypoints defining an anticipated route segment with said two waypoints as ends, said securing system being suitable for performing a first risk detection operation, as a function of at least the geographical coordinates of the ends of each segment and at least the geographical coordinates of the elements for identifying one or more potentially at-risk (segment, element) pairs as a collision risk potentially exists between the element of such a pair in the segment of said pair;

said system being characterized in that it is capable, each segment being split into segment sections each associated with geographical coordinates, of carrying out a second risk detection step for each (segment, element) at-risk pair identified in the first step, in order, based on at least the geographical coordinates of the sections of the segment of the pair and at least the geographical coordinates of the element of the pair, to determine whether said element is confirmed as presenting a collision risk with the segment of said pair.

According to a third aspect, the present invention proposes a computer program comprising software instructions which, when executed by a computer, carry out a method according the first aspect of the invention.

### BRIEF DESCRIPTION OF THE DRAWINGS

These features and advantages of the invention will appear upon reading the following description, provided solely as an example, and done in reference to the appended drawings, in which:

FIG. 1 shows a view of a securing platform in one embodiment of the invention;

FIG. 2 is a flowchart of steps implemented in one embodiment of the invention;

FIG. 3 is a view of provisional itinerary segments in one embodiment of the invention;

FIGS. 4 to 7 are views illustrating the processing done on polygons in one embodiment of the invention.

### DETAILED DESCRIPTION

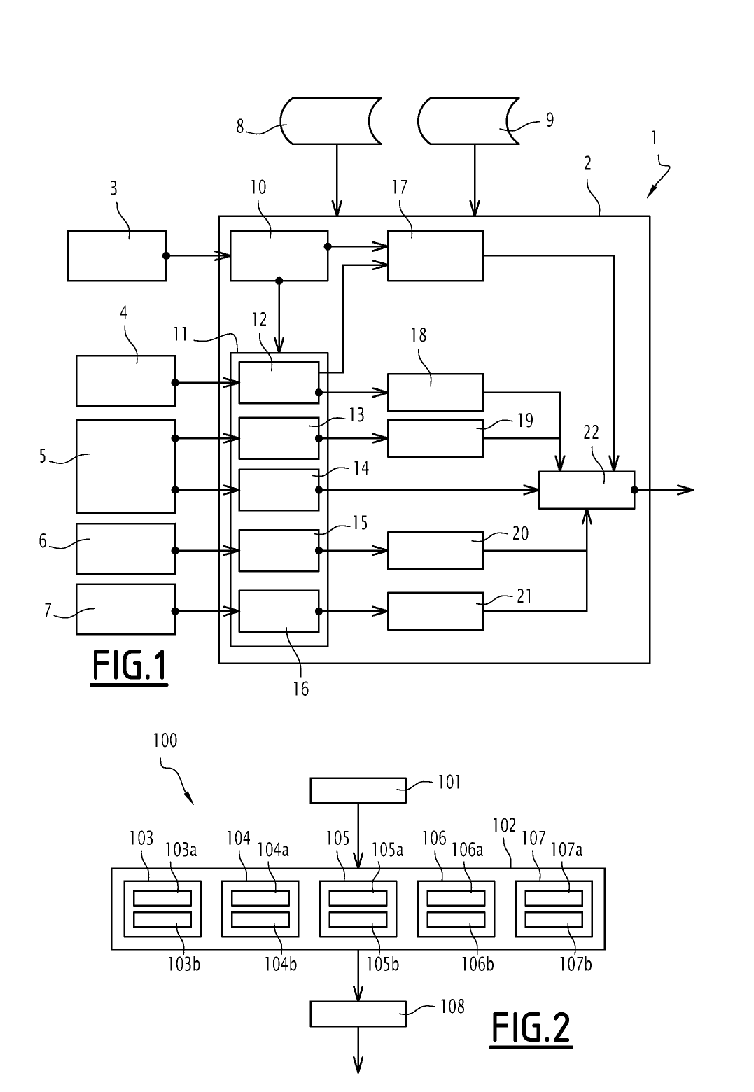

FIG. 1 shows a platform 1 for securing a provisional itinerary calculated for an aircraft. In the case considered here, the provisional itinerary is a flight plan of the aircraft. In another embodiment, the provisional itinerary is a path for example derived from the real-time in-flight redefinition of the predetermined flight plan.

The securing platform 1 has a securing system 2, a mission planning tool 3, a restriction provision tool 4, a terrain database (DB) 5, storing terrain elevations, MEA altitudes and obstacle definition data, traffic monitoring systems 6, weather servers/stations 7, a configuration tool 8 and a UTC date and time server 9.

In the considered embodiment, the securing system 2 has:
a provisional itinerary processing unit 10,
a unit 11 for processing potential threats for the aircraft suitable for processing the potential threats of various types such as a terrain elevation, periodic and linear obstacles, deteriorated weather situations, traffic, restrictions; the unit 11 includes:
   a unit 12 for processing terrain elevation data,
   a unit 13 for processing periodic and linear obstacle data,
   a unit 14 for processing weather data,
   a unit 15 for processing traffic data,
   a unit 16 for processing restrictions,
a unit 17 for the arrival airport,
a unit 18 for processing restriction-type polygons,
a unit 19 for processing obstacle-type polygons,
a unit 20 for processing traffic-type polygons,
a unit 21 for processing weather-type polygons,
a consolidation unit 22.

The operations performed by the various units of the securing system 2 in the considered embodiment are described below. All, or at least some, of these operations are implemented via the performance, on the calculating means of the securing system, of computer program software instructions.

### Provisional Itinerary Processing Unit 10

The unit 10 is suitable for receiving, as input, for example from a mission planning tool 3, a flight plan of the aircraft comprising waypoints (a starting point, an arrival point, midpoints between them). Each waypoint is associated with geographical data, for example latitude, longitude, altitude and predicted passage time of the aircraft.

The itinerary portion between two successive waypoints is referred to below as a segment (it is also known as a leg).

In one embodiment, the flight plan further indicates the changes between the different flight phases (end of takeoff, end of climb, beginning of descent, beginning of approach).

Furthermore, the unit 10 is suitable for receiving, as input, for example from the configuration tool 8 of the securing system 2, margin values to be applied between the extreme latitude and longitude values of each segment so as to provide an overlap of the geographical boxes produced by the unit 10, as described below.

According to the embodiments, the margins are set independently of the flight phases, or depend on the flight phases. In one embodiment, the margins vary dynamically and are provided by an external system.

The unit 10 is suitable for receiving, as input, a position error of the vehicle, for example coming from the configuration tool 8. According to the embodiments, this position error varies dynamically during the flight and is provided by an external system, or this position error is defined beforehand for the flight plan.

The provisional itinerary processing unit 10 is suitable for carrying out, in reference to FIG. 2, a set 101 of steps 1, comprising building a list of 2D geometric boxes, each 2D geometric box encompassing a respective segment of the flight plan in the 2D plane of the longitude/latitude coordinates. In the embodiment considered here, for each segment, the box associated with it is defined as the rectangle located between the minimum longitude and the maximum longitude of the segment, and between the minimum latitude and the maximum latitude of the segment—i.e., between the longitudes and latitudes of the ends of a segment in the considered present case where the itinerary is a linear function that increases or decreases monotonously over the segment or that is flat there along each of the longitude/latitude/altitude dimensions—the minimum values being increased by a negative margin and the maximum values being increased by a positive margin, further making sure that the difference in latitude between the ends of a segment (and also the difference in longitude) is indeed above a minimum threshold so as to guarantee a minimal overlap of the boxes. If that is not the case, a configurable arbitrary spur is added. The value of the margin for calculating these boxes is defined so as to encompass the position error on the aircraft and to cover the error on the location of the considered threat elements.

Each 2D box is then associated with an entry time He, an exit time Hs (respectively corresponding to the smallest and largest of the passage times of the aircraft at the ends of the segment) and a minimum and maximum altitude of the segment (Alte, Alts), which are, in the particular “monotonous linear function on each segment” case being considered, the altitudes of the ends of the segment. A 4D description of the box is thus obtained (3D box corresponding to the longitude/latitude/altitude coordinates+temporal dimension).

This list of boxes thus provides a rough depiction of the flight plan.

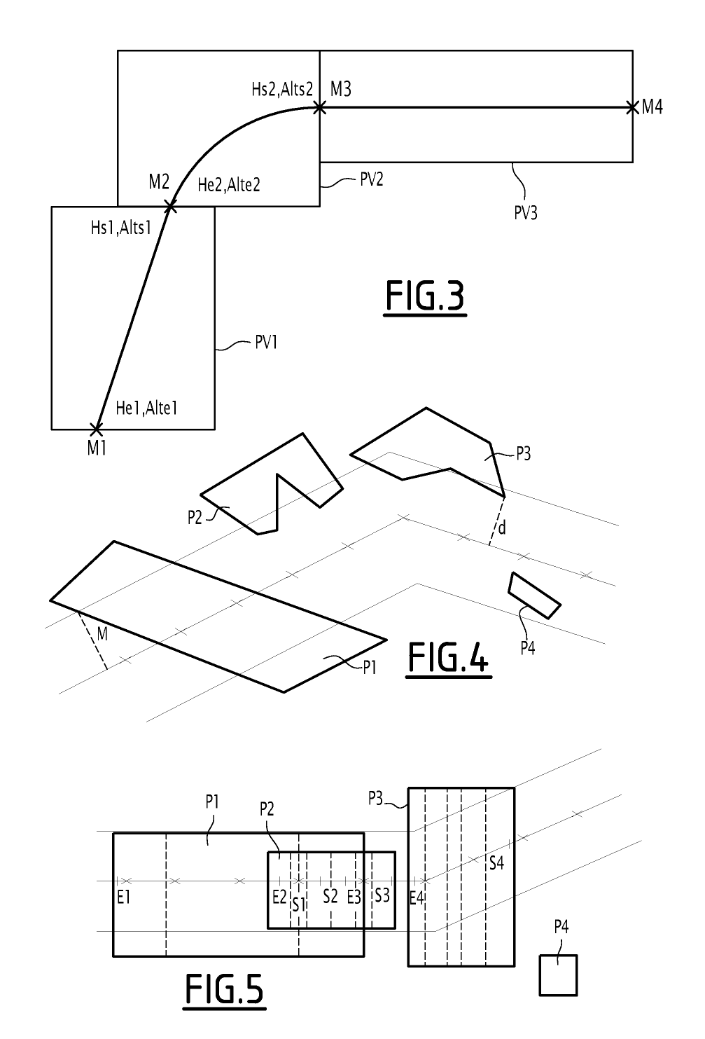

FIG. 3 shows, in the longitude/latitude coordinate plane, boxes PV1, PV2 and PV3 respectively built for the segments between the waypoints of the flight plan M1 and M2, M2 and M3, M3 and M4. The box PV1 is thus associated with an entry time He1 (which is the passage time associated in the flight plan with point M1), an exit time Hs1 (which is the passage time associated in the flight plan with point M2), and a minimum altitude Alte and maximum altitude Alts (respectively the smallest of the altitudes and the largest of the altitudes between those associated with M1 and M2 in the considered case).

The provisional itinerary processing unit 10 is further suitable for building a simplified flight plan, comprising the altitude constraints and estimated passage times. To that end, it is capable of subdividing each segment of the flight plan into fixed-sized sections, equal to or smaller than a given maximum size. The purpose of this step is to avoid managing overly large sections (a segment may measure several hundred nautical miles) and to account for the roundness of the Earth in the calculations (orthodromic path).

For straight segments, this subdivision is done by simply dividing each straight segment into several sections of predefined length, and while following the orthodromic heading.

Arc-of-circle segments are approximated by a series of straight sections. To that end, an algorithm of the Ramer-Douglas-Peucker type is for example used (for example using the tolerance equal to the position error divided by 2). Each obtained section is next subdivided again if necessary.

In one embodiment, the predefined and/or maximum section size varies based on the type of segment (straight or arc of circle) and/or the flight phase.

The provisional itinerary processing unit 10 is suitable for calculating and associating with each obtained section: an entry time (H′e) of the aircraft, in the section, and an exit time from the section (H's) corresponding to the passage time of the aircraft by the end of the section, and a passage altitude (Alt′e, Alt's) by these points. To that end, a linear variation algorithmic method is used between the points of the sections and the entry point and the exit point of the segment of the initial flight plan.

Then, the provisional itinerary processing unit 10 is suitable for associating, with each geographical box, the list of sections of the segment that it encompasses, the associated characteristics and the associated flight phases.

In the considered embodiment, the unit 10 is suitable for extracting, from the flight plan, the information indicating the arrival airport, the type of approach and the anticipated arrival runway, as well as the estimated time of arrival (“ETA”).

These two sub-steps for building geographical boxes and building a simplified flight plan are carried out upon each change of flight plan or each new flight plan and can be done in any order of precedence.

The provisional itinerary processing unit 10 thus provides, as output, in particular for the unit 11 and the polygon processing units 18, 19, 20, 21:
the list of geographical boxes including, for each one, an entry time, an exit time and the minimum and maximum altitudes of the aircraft associated with the box;
a 4D flight plan comprising a series of straight sections derived from the subdivision of the segments and including, for each of the sections, an arrival time, an exit time and a respective altitude for each of the two endpoints of the section (i.e., a minimum altitude and a maximum section altitude), as well as the associated flight phases.

The provisional itinerary processing unit 10 thus provides, as output for the arrival airport processing unit 17, the information indicating the airport, the type of approach, the arrival runway and the estimated time of arrival (“ETA”).

The unit 11 processing potential threats for the aircraft is suitable for receiving, as input, the list of geometric boxes and the flight plan subdivided into sections supplied by the provisional itinerary processing unit and for supplying these data to the processing units 11 to 14 suitable for processing the data representing the various potential threats.

### Unit 12 for Processing Terrain Elevation Data

The unit 12 for processing terrain elevation data is thus suitable for receiving as input:
the list of geographical boxes and the subdivided 4D flight plan as processed by the unit 10;
lateral and vertical margin levels with respect to the flight plan derived from the configuration of the device or an external system (for example, the tool 8); for example, the margins are around ten kilometers;
the information, from the terrain DB 5, on terrain elevations as well as the MEA altitudes (“Minimum En-route Altitude”, the lowest possible flying altitude between two beacons making it possible both to cross the terrain and obstacles and to receive radio assistance).

In the considered embodiment, with the aim of preserving the computing load, the cruising phase is analyzed roughly first, and more finely secondly, and only over the zones presenting a risk according to the first rough analysis. In the considered embodiment, furthermore, the phases closer to the ground (takeoff phase and descent/approach phase), if they are included in the flight plan, are analyzed finely and systematically (in other embodiments, it is more generally the flight phases beyond a certain altitude that are analyzed more roughly first, and more finely secondly only over the zones presenting a risk according to the first rough analysis; the flight phases below said certain latitude being analyzed finely and systematically). To do this, in reference to FIG. 2, in a step 103, the unit 12 is capable of performing the following operations, after having identified the geographical boxes covering all or part of the cruising phase, and covering all or part of the landing and takeoff phases:

For the cruising phase, in a sub-step 103a:
for each geographical box covering part of the cruising phase: extracting the valid MEA data;
comparing the MEA data to the minimum altitude of the aircraft over each geographical box (output data from the unit 10); and in case of conflict for a box (i.e., if the minimum altitude of the box is below a MEA altitude relative to said box), in a step 103b:
extracting the sections from the 4D flight plan associated with the box;
extracting the terrain elevation information, corresponding to the box, from the terrain DB 5 and adding the margins thereto, in order to obtain the terrain profile corresponding to the box;
performing a comparison between the terrain profile thus supplemented by the margins and the sections of the 4D flight plan extracted for this geographical box by for example applying an algorithm of the TAWS type along said sections to detect the collision risks (in particular a terrain elevation greater than the minimum altitude of a section, or smaller but with a difference below a given safety threshold);
in case of collision risk thus detected between a section and the corresponding terrain elevations, the unit 12 identifies the section as presenting a collision risk and associates it with an associated risk level, based on predefined criteria.

For the takeoff and landing phases, the unit 12 is capable of taking the sections of the 4D flight plan that are entirely or partially included in said phases and directly applying sub-step 103b to said sections to identify, among them, the sections at risk of collision and the associated risk level.

These operations are carried out by the terrain elevation data processing unit 12 upon each change of flight plan or each new flight plan.

Each unit 12 thus delivers, as output, the list of sections identified as collision risks with the terrain and the associated risk level.

### Unit 13 for Processing Periodic and Linear Obstacle Data

This unit 13 processes the obstacles derived from man-made structures, which may be periodic (for example, buildings) or linear (for example, high-voltage lines, telephone cables, illuminated marking elements, etc.).

It receives, as inputs:

the list of geographical boxes;

from the DB 5: the geographical coordinates of fixed obstacles, whether periodic or linear, their height, as well as the uncertainty related to these characteristics (this information may be built in the DB 5 statically on the ground and/or dynamically using information entered by an operator or supplied by one or more sensors).

The unit 13 serves to extract the relevant obstacles in polygon form. It is thus capable, upon each change of flight plan or each new flight plan and in case of change to the list of obstacles, in reference to FIG. 2, in a step 104a of a process 104 for processing obstacle data, for each geographical box from the list of boxes, of:

extracting the obstacles whose latitude and longitude are contained in the 2D section, according to the latitude and longitude coordinates, of the geographical box and depicting each extracted obstacle in the form of a polygon in the latitude/longitude plane, with the associated height (if this height information is not available for the obstacle in question, it is considered infinite);

comparing the height of each obstacle, including a margin and the uncertainty associated with the minimum altitude of each geographical box;

in case of conflict (i.e., if the added height with margin and uncertainty exceeds the minimum altitude of the box or is lower but not by a given minimum distance), identifying the polygon as an “at risk” polygon and determining the associated risk level according to predetermined criteria.

It provides, as output for the obstacle-type polygon processing unit 19, a list of polygons associated with each geographical box and representing the obstacles that can be “at risk”, including, for each polygon, the longitude/latitude coordinates of the various points of the polygon, the high altitude and the low altitude of the polygon (generally nil), comprising the position uncertainty, the height uncertainty, the nature of the obstacle (linear, periodic, etc.) and the risk level.

### Unit 14 for Processing Weather Data

The unit 14 receives, as input:

the current “UTC” (universal time coordinated) date and time of the UTC server 9;

the list of geographical boxes;

a list of weather operators/servers 7 on the ground and covered geographical zones respectively associated with the weather stations/servers; typically, these stations/servers have information of the SIGMET (“SIGnificant METeorological Information)” type;

lists of grouped polygons, coming from the weather stations/servers 7 (in response to a request, as described hereinafter). Each list includes a group of polygons used to represent a weather object (a storm, an anticipated turbulence zone, a thunderstorm, ice, etc.) and its evolution over time using a temporal tag. The polygons contained in this list intersect such that there is no geographical space between two adjacent polygons in a same group;

a temporal margin derived from the configuration of the device or an external system.

The weather data processing unit 14 is suitable, in reference to FIG. 2, in a step 105a of a process 105 processing weather data, for:

building the request(s) with weather operators 7 to cover each geographical box of the list (these requests are generally much more encompassing and may for example cover the various countries flown over by the aircraft),

then, periodically in order to recover up-to-date weather data (the weather data relative to a geographical zone), sending the built requests to the weather operators 7: a new request iteration is thus done periodically on all of the geographical boxes for which the entry time in the box is greater than the current UTC time and, if applicable, for the box whose entry date and exit date frame the current UTC time;

processing the received responses by merging them to convert them into a list of valid sequenced polygons at the time of the request; the polygons are defined in the longitude/latitude plane and are associated with a low altitude and a high altitude, thus geographically bounding the weather phenomenon at a given time;

sequencing the lists of polygons by geographical coordinates, by temporal tagging and by high altitude. During this step, only the polygons are kept:

that are contained in one of the geographical boxes (to determine this, a simple comparison of the latitudes/longitudes is done), and

for which the start date of the phenomenon is earlier than the exit date of the aircraft from the box and for which the end date is after the entry date of the aircraft into the box, and

that are associated with a weather phenomenon that may present a risk.

The weather data processing unit 14 therefore provides an output, intended for the weather polygon processing unit 21:

a list of polygons attached to each geographical box and sequenced by longitude, latitude geographical coordinates, by temporal tagging and by altitude

the type of weather risk associated with each polygon.

### Unit 15 for Processing Traffic Data

The traffic data relative to the air or other traffic (maritime, for example) is sent periodically and come from collaborative systems (i.e., sending data from ADS-B, flarm or AIS systems) and/or non-collaborative systems (i.e., the position and heading or speed information of which are transmitted by a third party, such as the air traffic control “ATC” service on the ground or by a radar or electro-optical sensor, for example).

The unit 15 has, as input:
the current UTC date and time of the UTC server 9;
the list of geographical boxes;
a list of traffic data coming from the traffic surveillance systems 6, indicating, for each identified vehicle, the type of vehicle, the identification of the vehicle, its position (latitude, longitude, altitude), its actual heading, its speed;
a temporal margin coming from the configuration of the system 2 or an external system, for example the configuration tool 8 (the temporal margin corresponds to the time delta that the aircraft using the system 2 may have relative to the predictions made on its entry and exit from a geographical box).

The traffic data processing unit 15 is capable of processing the received traffic data to convert it into a list of sequenced polygons.

Thus, during a process 106 for processing traffic data, in reference to FIG. 2, in a step 106a, upon each update of the traffic data, it is capable of:

recovering the list of traffic data;

sequencing the traffic elements by geographical coordinates and by altitude. During this step, the only traffic elements kept are those for which the longitude/latitude are contained in the section, in the surface of the longitude and latitude, of at least one of the geographical boxes: to determine it, a simple comparison of the latitudes/longitudes of the traffic elements and boxes is thus done;

converting the traffic elements into polygons using the characteristics (latitude, longitude, altitude) and associating therein, with each polygon, the speed of the corresponding traffic element and the uncertainty of the element (the uncertainty indicates the imprecision regarding the position of a traffic element; it is taken into account for example by increasing the size of the polygon based on the period in which the traffic data is received, the precision of the source data and the speed of the considered traffic element).

The traffic data processing unit 15 therefore provides as output, intended for the traffic polygon processing unit 20:
a list of traffic polygons attached to each geographical box and sequenced by longitude, latitude geographical coordinates and by altitude (here in general high altitude=low altitude);
the characteristics associated with each traffic element.

It will be noted that according to the embodiments, this traffic data provided at the output of the traffic data processing unit 15 may next be processed separately from the obstacles (in the case at hand, respectively by the traffic polygon processing unit 20 and by the obstacle polygon processing unit 19), or in a merged manner, independently of the origin of the polygons.

### Unit 16 for Processing Restrictions

Restrictions in particular indicate zones prohibited by air traffic control or at-risk zones (for example following a fire, a war, etc.), zones prohibited by the operator of the aircraft, zones that are uncomfortable to pass through in terms of weather or runway condition, etc.

They are for example sent via E-NOTAM (Electronic-Notice To Air Men) messages called restriction messages.

The unit 16 for processing restrictions receives as inputs:
the current UTC date and time of the UTC server 9;
the list of geographical boxes;
the E-NOTAM data from the tool for supplying E-NOTAM restrictions 4;
in one embodiment, prohibited zone data from an on-board database;
a temporal margin derived from the configuration of the device or an external system.

The E-NOTAMs being sent when they are created, the restriction processing unit 16 builds a request for each geographical box in the list, defined by its 2D longitude and latitude coordinates. This request seeks to receive all of the E-NOTAMs applicable to this box at the moment of the request in response.

The restriction processing unit 16 is capable, in a step 107a of a process 107 for processing restriction data and in reference to FIG. 2, periodically in order to recover up-to-date E-NOTAM data, of:
reiterating the sending of one request per geographical box over all of the geographical boxes for which the entry time of the box is greater than the current time UTC and, if applicable, for the box for which the entry date and exit date frame the current time UTC;
extracting the associated data from the on-board database (if present);
extracting the E-NOTAM data received in response to the reiterated requests;
sorting the E-NOTAM data extracted by geographical box and by geographical latitude/longitude coordinates as well as by altitude;
   sorting the E-NOTAMs based on their temporal data (start date, end date) so as only to keep, by geographical box, the E-NOTAMs for which the start date is earlier than the exit date from the box and for which the end date is after the entry date into the box;
converting the information contained in the E-NOTAMs into polygons in the longitude/latitude plane when the E-NOTAM relates to zone information, and if applicable associating it with altitude information (high and low altitudes) [if these altitudes do not exist at this stage, a minimum altitude of zero and an infinite maximum altitude are considered], the polygon being defined by the coordinates of the different points of the polygon, object type (weather risk, restricted airspace, forbidden airspace, etc.), applicability (IFR flight, specific carrier (for example, any helicopter except ambulance service), etc.);
extracting, from E-NOTAMs related to airport information, the information relative to the airport and the associated runways.

The unit 16 for processing restrictions therefore provides, as outputs:
for the restriction polygon processing unit 18: a list of polygons associated with each geographical box and sequenced by longitude, latitude and altitude geographical coordinates; each polygon is further associated with the type of risks or restrictions;
for the arrival airport processing unit 17: the list of E-NOTAMs associated with the destination airport of the flight plan and the associated runways.

### Processing Unit 17 for the Arrival Airport:

The processing unit 17 for the arrival airport receives, as inputs:
the airport, the type of approach and the runway, as well as the ETA;
the E-NOTAM data relative to this airport and the associated runways.

The arrival airport processing unit 17 is capable, upon each change of flight plan or new flight plan, of:
decoding the E-NOTAMs by using the associated standardized nomenclature;
extracting the data relative to the arrival runway from the received E-NOTAMs;
comparing the temporal data from the E-NOTAMs with the estimated time of arrival (ETA) in order to determine the applicable E-NOTAMs;
for each applicable E-NOTAM, determining whether it calls the mission into question by restricting/prohibiting the ability to use the anticipated runway as planned;

The causes may be: runway closed, maintenance action on equipment needed on the approach, etc.

And if it has been determined as calling the mission into question, producing an associated restriction message, containing:
the risk category: mission not affected, mission affected or mission potentially called into question;
the list of restrictions associated with the arrival airport.

The arrival airport processing unit 17 provides, as output, a landing restriction message related to the arrival airport, intended for the consolidation unit 22.

### Polygon Processing Units 18, 19, 20, 21

A polygon processing unit such as one of the polygon processing units 18, 19, 20, 21 receives, as input:
the current UTC date and time;
the list of geographical boxes and the 4D flight plan subdivided into sections coming from the processing unit 10;
a list of polygons attached to each geographical box and for example sequenced by longitude, latitude geographical coordinates and by altitude;
lateral and vertical margins (according to the embodiments, the margins are fixed and vary as a function of the flight phase or the margins vary dynamically and are provided by an external system, for example by the configuration tool 8); for example, the margins, with values lower than those used by the units previously described, are between 100 and 200 meters;
monitoring distances for lateral and vertical moving objects (these distances are used below to identify the polygons “to be watched”, i.e., outside a corridor with size 2M centered on the flight plan, but the distance of which from the flight plan is below a certain threshold and for which the speed vector converges toward the flight plan, the function identifies it as being given that the flight plan information of the polygon is not available, the hypothesis is adopted that the object associated with the polygon is able to stop or change direction); depending on the embodiments, these distances from moving objects are fixed and vary depending on the flight phases, or the moving object monitoring distances vary dynamically and are provided by an external system, for example by the configuration tool 8);
a position error with respect to the position of the vehicle (depending on the embodiments, this position error varies dynamically and is provided by an external system, for example by the configuration tool 8, or this position error is known along the anticipated flight plan).

Each polygon processing unit 18 to 21 is capable of determining the collision risks between a respective type of polygon (weather, traffic, etc.) that is presented to it and the flight plan.

It is thus capable, upon each change of flight plan or each new flight plan, as well as in case of update of the list of polygons, of carrying out the operations described below in a step 104b for the processing unit of the obstacle polygons 19, based on the list polygons provided by the obstacle processing unit 13, in a step 105b for the weather polygon processing unit 21, based on the list of polygons provided by the weather data processing unit 14, in a step 106b for the traffic polygon processing unit 20, based on the list of polygons provided by the traffic data processing unit 15, in a step 107b for the restriction polygon processing unit 18, based on the list of polygons provided by the restriction processing unit 16.

Thus, a polygon processing unit 18, 19, 20 or 21 is capable of:

taking for each geographical box, the list of path sections that are associated with it as well as the list of polygons attached to the box received as input by the polygon processing unit;

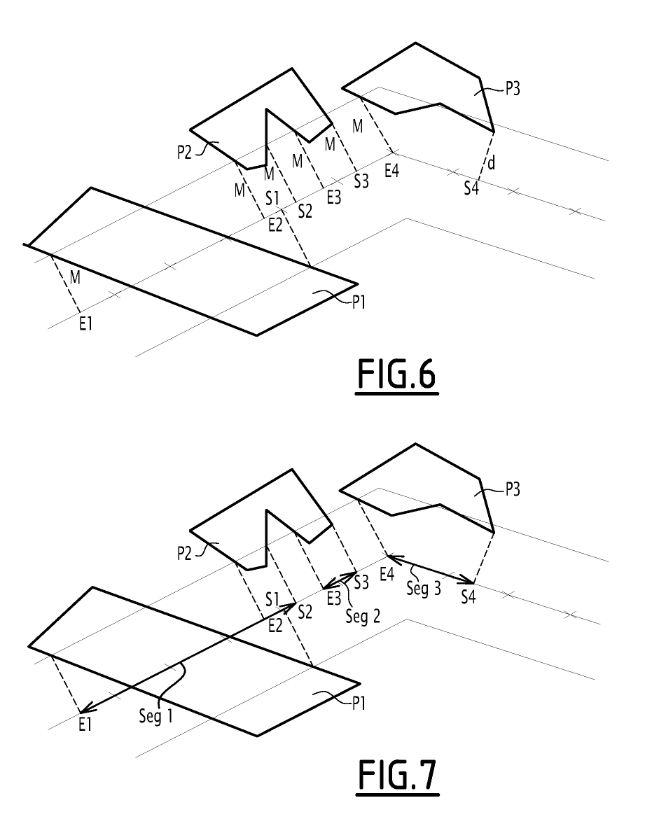

for each polygon:
for each apex of the polygon:
looking for the associated path section closest to the apex, in the longitude and latitude 2D space, compared with the latitudes and longitudes;
projecting, in two dimensions (longitude and latitude), the apex of the polygon on the segment. The aim here is to determine whether the polygon is outside the corridor with width 2M centered on the section in the longitude/latitude plane or if it is completely or partially integrated into the corridor, as shown in FIG. 4 in the longitude/latitude plane based on the polygons P1, P2, P3, P4. To that end, the unit 18, 19, 20 or 21 is capable of:
determining whether the distance d between said section and the apex of the polygon is less than M, equal to the lateral margin increased by the position error M. If so, then the tip is located inside the corridor defined around the section. If this is not the case, then the tip is located outside said corridor;
determining, by comparing latitude and longitude, on which side of the path section the apex of the polygon is located.
   Once these steps are performed for each apex of the polygon: if there is no apex of the polygon located inside the corridor and if, furthermore, all of the apices of the polygon are located on the same side of the section, then the polygon is outside the corridor. Otherwise, the polygon is completely or partially integrated into the corridor. In the latter case, the polygon processing unit is capable of comparing the minimum altitude and the maximum altitude of the polygon intercepting the itinerary with the altitude of the considered intercepted path sections. If there is overlap, the polygon is considered to be located completely or partially in the corridor; if not, it is dismissed as not presenting any risks. FIG. 5 is a view in the latitude/altitude plane of the polygons of FIG. 4. The polygons are thus delimited therein by the latitudes of their apices and by their minimum and maximum respective altitudes. In the case shown in FIG. 5, the polygon P4 is therefore dismissed from among the polygons P1, P2, P3 and P4.
   For each polygon side considered to be located completely or partially in the corridor, the itinerary points corresponding to the entry into the polygon and the exit from the polygon (Ex/Sx) are next determined. To that end, for each polygon side located inside the corridor or intersecting the corridor, the following approach is adopted, as shown in FIG. 6, in the longitude/latitude plane:
   if the polygon side is located completely inside the corridor, the corresponding points located on the provisional itinerary are determined directly via the orthogonal projection of each apex of the considered polygon side on the provisional itinerary segment closest to each apex;
   if the polygon side is completely or partially straddling the corridor, the entry/exit point (Ex/Sx) in the polygon is determined by looking for the orthogonal projection of each point associated with the intersection of the corridor with a side of the polygon, on the itinerary segment closest to the point.

For each pair of entry/exit points thus obtained, a passage time of the aircraft is next determined by using a linear variation of the speed along the itinerary section containing the entry and exit point, respectively. This passage time is next compared to the temporal validity tag of the polygon (if one exists).

If the determined passage time increased or decreased by the temporal margin (this temporal margin received as input corresponds to the time delta that the aircraft using the system 2 may have relative to the forecasts done regarding its entry and exit from a geographical box) fits with the temporal validity tag of the polygon (i.e., the temporal tag is comprised within the [determined passage time-margin, determined passage time+margin] interval) or if there is no temporal validity tag (the polygon is in this case considered always to be valid), then there is a collision risk and the polygon is identified as “at risk” by the polygon processing unit.

If the polygon is associated with a speed vector (case of traffic elements, for example), the level of the determined risk for the polygon may be modulated, or the “at risk” identification canceled, based on the amount of time needed for the aircraft to reach the 1st point of entry into the polygon. Given that the flight plan information of the polygon is not available, in order to determine the risk level, the hypothesis is adopted that the object associated with the polygon may stop or change direction.

In the considered embodiment, the polygon processing unit identifies the path sections having a collision risk with a threat: these “at-risk” sections (Seg x) are all of the path sections located, in whole or in part, between a point of entry Ex into a polygon as calculated above and the exit point from said polygon, or the last of the consecutive exit points Sx encountered according to the flight plan from this exit point from said polygon in the case where said exit point is followed by other polygon exit point(s) without polygon entry point arranged between them. In reference to FIG. 7 showing the polygons in the longitude/latitude plane, the polygon processing unit thus identifies the “at-risk” path sections as all of the path sections located, in whole or in part, on the section Seg1 (between E1 and S2), the section Seg2 (between E3 and S3) and the section Seg3 (between E4 and S4), the points E1/S1 being determined entry/exit points for the polygon P1, the points E2/S2 and E3/S3 being determined entry/exit points for the polygon P2 and E4/S4 being determined entry/exit points for the polygon P3 (these entry/exit points are also shown in FIGS. 5 and 6). These points E1, S1, E2, S2, E3, S3 and E4, S4 were determined as indicated above, by orthogonal projection (shown in dotted lines in FIGS. 6 and 7) on the itinerary.

In one embodiment, a risk avoidance limit point is further calculated by the polygon processing unit, for example positioned upstream from the point of entry along the flight plan at a distance D depending on the speed of the aircraft at the time of entry into the path section identified as “at risk”. The distance D is calculated taking into account a time needed to perform the avoidance, which depends on the speed of the aircraft (the faster it goes, the less maneuverable it generally is).

In one embodiment, the polygon processing unit further identifies, as “to be watched”, the polygons outside the corridor, but the distance d of which from the flight plan is below a certain threshold and for which the speed vector converges toward the flight plan. Given that the flight plan information of the polygon is not available, the hypothesis is adopted that the object associated with the polygon may stop or change direction.

In the considered embodiment, each polygon processing unit 18, 19, 20, 21 delivers, as output, to the consolidation unit 22:
a list of “at-risk” sections with, in embodiments, an associated risk level, the polygons “to be watched” and the “at-risk” polygons;
for each “at-risk” section, the collision risk start and end of collision times with the polygon (which are the passage times determined above for the aircraft at the ends of these sections), and optionally, the avoidance limit point;
for each polygon, its characteristics (nature of the object, latitude/longitude of the apices, high and low altitudes, if applicable temporal validity tag, movement speed and direction).

In the considered embodiment, the polygons associated with one threat type are processed independently of the polygons associated with other threat types, by respective polygon processing units. In other embodiments, a global processing unit processes all of the polygons together.

### Consolidation Unit 22

The consolidation unit 22 uses, as input data:
the flight plan supplied by the mission planning tool 3, in particular comprising the longitude/latitude 2D path;
the 4D flight plan delivered at the output by the flight plan processing unit 10;
the landing restriction message related to the arrival airport;
by threat type:
   a list of “at-risk” sections and the associated “at-risk” polygons (optionally “no risk”, “to be watched”); and
   for each section, the collision risk start and end of collision times with the polygon and optionally, the risk avoidance limit point;
   for each polygon, its characteristics (nature of the object, latitude/longitude of the apices, high and low altitudes, if applicable temporal validity tag (when the corresponding threat has a determined existence duration), movement speed and direction).

The consolidation unit 22 is capable, upon each change of flight plan or new flight plan, as well as in case of update to the threat list, in a step 108, in reference to FIG. 2, of:
merging the various at-risk sections and concatenating the lists of polygons “to be watched” and “at risk”;
publishing the list of “no-risk” polygons;
determining the highest threat level;
in one embodiment, determining the closest avoidance limit point; and
publishing them for the on-board crew, for example.

Depending on the embodiments, the securing system 2 may be installed fully in a ground mission preparation system or be completely on board the aircraft. In another embodiment, the processing operations are distributed between the ground and the aircraft, for example the obstacle processing unit 11, responsible for collecting data and formatting it, is on the ground, while the other processing operations, responsible for analysis and verification, are on board. Data transmission means are then implemented between the two parts. The interest of this device lies in concentrating data collection and formatting as close as possible to the suppliers of this data.

The invention, by first performing a macro-analysis of the provisional itinerary, then a detailed analysis done only on a subset of threats related to a subset of route sections identified as critical during the macro-analysis, makes it possible to reduce the necessary computing resources.

The invention also makes it possible to guarantee, quickly and reliably, the viability (within the meaning of cybersecurity) of an itinerary provided by an external system (of the ground station type) without using complex and costly encryption in terms of computing time.

The use, in the considered embodiment, of polygons to depict various threats makes it possible to pool and streamline the algorithmic processing operations done, which again allows a gain in terms of computing resources.

The invention proposes not only to validate that a calculated itinerary is secured, and further accounts for the evolution, over time, of the risks related to the provisional itinerary.

In the considered embodiment, an overall status is thus provided to the crew, relative to all of the threats and the entire provisional itinerary.

The invention has been described in an embodiment taking account of threat elements of various types and proposing a wide variety of processing operations. Of course, in other embodiments, only certain types of threat elements are taken into account in a securing system, for example the terrain elevation and periodic and linear obstacles, and only some of the described processing operations are implemented, for example without restriction processing, or arrival airport processing, etc.

1. A method, implemented by computer, for securing a provisional itinerary calculated for an aircraft with respect to a set of elements representing potential threats, each element being associated with characteristics comprising at least geographical coordinates, according to which the calculated provisional itinerary for the aircraft comprises a list of waypoints of the aircraft each associated with geographical coordinates, two successive waypoints defining an anticipated route segment with said two waypoints as ends, said method comprising:
carrying out a first risk detection, as a function of at least the geographical coordinates of the ends of each segment and at least the geographical coordinates of the elements to identify one or more potentially at-risk (segment, element) pairs when a collision risk potentially exists between the element of such a pair in the segment of said pair, wherein each segment is split into segment sections each associated with geographical coordinates; and
further carrying out a second risk detection for each (segment, element) at-risk pair identified in the first risk detection, in order, based on at least the geographical coordinates of the sections of the segment of the pair and at least the geographical coordinates of the element of the pair, to determine whether said element is confirmed as presenting a collision risk with the segment of said pair.

2. The securing method according to claim 1, wherein said carrying out a first risk detection comprises determining whether an element is within a 3D volume associated with a segment and defined based on at least the coordinates of each segment, said 3D volume encompassing said segment and the (segment, element) pair being identified as at-risk pair as a function of said determining.

3. The method according to claim 2, wherein the coordinate system of the coordinates has 3 dimensions X, Y and Z and in the first risk detection, in order to determine whether an element is located within the 3D volume, a comparison is first done of the coordinates of the element and the volume according to one of said dimensions, respectively two of said dimensions, the (segment, element) pair being selected based on the comparison, then a further comparison is done, only if the pair has been selected, of the coordinates of the element and the volume according to the last two dimensions, respectively the last dimension, the (segment, element) pair being identified as at-risk pair based on the further comparison.

4. The method according to claim 1, wherein the coordinate system comprises 3 dimensions X, Y and Z and the threats comprise obstacles and/or deteriorated weather situations and/or other anticipated traffic, wherein the threat elements are shown by polygons in two-dimensional space (X,Y), and wherein in the second detection, sections of the segment are determined that are closest to the apices of a polygon and the elements are confirmed as presenting a collision risk in the second detection as a function of said determined sections, and segment portions considered as being at-risk for said elements are calculated as a function of said determined sections and geographical coordinates of said elements.

5. A computer program for securing a provisional itinerary calculated for an aircraft with respect to a set of elements representing potential threats comprising software instructions which, when executed by a computer, carry out a method according to claim 1.

6. A system for securing a provisional itinerary calculated for an aircraft with respect to a set of elements representing potential threats, each element being associated with characteristics comprising at least geographical coordinates, the calculated provisional itinerary for the aircraft comprising a list of waypoints of the aircraft each associated with geographical coordinates, two successive waypoints defining an anticipated route segment with said two waypoints as ends, said securing system performing a first risk detection operation, as a function of at least the geographical coordinates of the ends of each segment and at least the geographical coordinates of the elements to identify one or more potentially at-risk (segment, element) pairs when a collision risk potentially exists between the element of such a pair in the segment of said pair, wherein each segment is split into segment sections each associated with geographical coordinates, and wherein the system carries out a second risk detection for each (segment, element) at-risk pair identified in the first risk detection, in order, based on at least the geographical coordinates of the sections of the segment of the pair and at least the geographical coordinates of the element of the pair, to determine whether said element is confirmed as presenting a collision risk with the segment of said pair.

7. The securing system according to claim 6, determining, in the first risk detection operation, whether an element is within a 3D volume associated with a segment and defined based on at least the coordinates of each segment, said 3D volume encompassing said segment and identifying the (segment, element) pair as an at-risk pair based on the determining.

8. The securing system according to claim 7, wherein the coordinate system of the coordinates has 3 dimensions X, Y and Z, and wherein the system, in the first risk detection operation of determining whether an element is located within the 3D volume, first compares the coordinates of the element and the volume according to one of said dimensions, respectively two of said dimensions, and selects the (segment, element) pair based on the comparing, then further compares, only if the pair has been selected, the coordinates of the element and the volume according to the last two dimensions, respectively the last dimension, and identifying the (segment, element) pair as an at-risk pair, based on the further comparing.

9. The securing system according to claim 6, wherein the coordinate system comprises 3 dimensions X, Y and Z and wherein the threats comprise obstacles and/or deteriorated weather situations and/or other anticipated traffic, and wherein the system shows the threat elements by polygons in two-dimensional space (X,Y), and, in the second risk detection, determines sections of the segment that are closest to the apices of a polygon and confirms the elements as presenting a collision risk in the second risk detection based on the determined sections, and calculates segment portions considered as being at-risk for said elements as a function of said determined sections and geographical coordinates of said elements.
